(19) United States
(12) Patent Application Publication
(10) Pub. No.: US 2015/0369093 A1
(43) Pub. Date: Dec. 24, 2015

(54) VARIABLE ELECTROHYDRAULIC VALVE CONTROL SYSTEM

(71) Applicant: LSP INNOVATIVE AUTOMOTIVE SYSTEMS GMBH, Oberriexingen (DE)

(72) Inventors: Heinz LEIBER, Oberriexingen (DE); Jochen KELLER, München (DE); Thomas LEIBER, München (DE); Lars KRAUSE, Neufahrn bei Freising (DE)

(73) Assignee: LSP INNOVATIVE AUTOMOTIVE SYSTEMS GMBH, Unterföhring (DE)

(21) Appl. No.: 14/762,331

(22) PCT Filed: Jan. 16, 2014
(86) PCT No.: PCT/EP2014/050784

§ 371 Date: Jul. 21, 2015

(30) Foreign Application Priority Data
Jan. 22, 2013 (DE) 10 2013 100 632.9

(51) Int. Cl. F01L 9/02; G05D 7/06; G05D 16/20; F16K 31/04

(52) U.S. Cl. CPC F01L 9/025; F16K 31/047; G05D 7/0641; G05D 16/202

(57) ABSTRACT

The invention relates to a variable electrohydraulic valve controller, comprising a piston, which is arranged in such a way that the piston acts on a valve, particularly a gas exchange valve of an internal combustion engine, in order to actuate said valve, a valve hydraulic chamber bounded by said piston, and at least one piston-cylinder unit, which is connected to the valve hydraulic chamber by means of a hydraulic line in which a switching valve is arranged. According to the invention, the piston (14) of the piston-cylinder unit (14, 15) is driven by a drive. particularly a motor.

The present invention relates to a variable electrohydraulic valve control system according to the preamble of patent claim 1.

### PRIOR ART

Such valve control systems are used, for example, for controlling gas exchange valves of motor vehicles. A differentiation is in principle made between mechanical or electromechanical valve control systems and hydraulic or electrohydraulic valve control systems.

Variable valve drives or valve control systems are becoming increasingly significant. In particular for Otto or diesel internal combustion engines, increasing variability is required, in particular in order to reduce the exhaust gas emissions and the fuel consumption. Existing systems are limited in terms of variability, excessively complex and have an excessively high level of losses as a result of a poor degree of efficiency and are too imprecise in terms of control.

There is known, for example, from WO 2008/107111 A1 an electromechanical valve control system having camshaft adjustment. Since, in this valve control system, the valve stroke profiles are predetermined by means of camshaft contours, it has limited variability since a selection has to be made in this instance between two valve stroke profiles.

DE 10 2006 013 100 A1 discloses a segment motor for a valve drive, by means of which, as a result of improved adjustment possibilities of the valve stroke, the variability can be expanded, wherein each valve is controlled by means of an electromechanical segment motor with an end stage/actuator.

This is a completely variable system in which the stroke and control time can be varied. However, this solution has a relatively high weight and is comparatively expensive. Furthermore, it requires a high level of technical regulation complexity in order to ensure low placement speeds and a high level of complexity in the event of valve failure.

EP 1 691 041 A2 sets out an electrohydraulic valve control system of the type mentioned in the introduction. In this relatively simple variable valve control system, the camshaft acts on a hydraulic system. A similar system which is improved in terms of failure reliability is known from DE 10 2008 049 181 A1. In these solutions, the variability is also still limited since profiles smaller than the camshaft shape and the valve closure profiles are coupled to the camshaft profile. In addition, the control time variability (opening and closing control time angle variation) is limited. Furthermore, in these systems, there is a relatively high power requirement and an inadequate level of precision. A solution for venting the system is not provided.

### PROBLEM AND SOLUTION OF THE INVENTION

An object of the invention is to improve a variable valve control system of the type mentioned in the introduction in such a manner that, with a relatively low level of complexity, complete variability (valve stroke and control times) is achieved.

This object is achieved according to the invention with the features of patent claim 1.

With the solution according to the invention, there is provided a device and a method for fully variable valve control which allows precise regulation and moreover a high level of valve control precision. The variability relates in particular to the stroke variation, wherein the valve strokes may be larger or smaller than the camshaft contour and the control time variation. For example, power increases at full load by means of stroke increase in comparison with the camshaft are possible. The variability is provided with a central, preferably electromotive plunger unit which varies the volume of the valve hydraulic chamber for valve control. This unit may be used centrally for all valve control systems (inlet and outlet valves) for internal combustion engines having four cylinders or more.

The advantages of the invention can be achieved with a small weight and structural space and low costs. Thus, for example, only four valves and one plunger drive unit are sufficient for the operation of a four cylinder motor, in which the inlet valves are constructed in a variable manner and two valves are combined with a hydraulic chamber.

Furthermore, the invention is distinguished by a low power requirement, which enables operation at 12 V (standard on-board system) and a high level of availability (emergency operation in the event of component malfunction).

Advantageous embodiments and developments of the invention are contained in the additional patent claims.

The invention or the advantageous embodiments and developments thereof further afford the following additional advantages in particular:
noise-free operation since the camshaft contour controls the closure operation (no high demands in terms of regulation in order to achieve low valve placement times);
regulation without a valve stroke sensor is possible since the camshaft regulates the closure operation;
a significantly higher level of precision of the valve stroke regulation compared with other hydraulic valve control systems and a possibility for producing mini-strokes since the valve regulation is significantly more precise with motor position regulation in comparison with time control of valves;
very simple cylinder shutdown by separating the camshaft from the hydraulic chamber with only one valve per camshaft. Consequently, a further reduction of the fuel consumption is inter alia possible since, for example, in travel situations with low power requirement, no fuel is injected into the switched-off cylinder(s), wherein the valves of the switched-off cylinders are advantageously kept closed in order to prevent gas exchange losses. Depending on the system or requirement, it is possible to switch off individual cylinders or cylinder combinations. The shutdown of cylinders can in addition be carried out much more rapidly in comparison with mechanical systems;
in addition, a simple solution for venting the system is set out;
other advantageous embodiments relate to the emergency operation in the event of a system failure, leakage compensation of the system, the maintenance of a minimum pressure level in the valve hydraulic chambers, an active venting procedure and additional advantageous procedures for completely switching off the valves.

Embodiments of the invention and the configurations thereof, and additional features and advantages will be appreciated from the following description and the drawings, to which reference is made.

### IN THE DRAWINGS

FIG. 1: shows the schematic structure of the valve control system;

FIG. 1a: shows a linear actuator as an alternative to the motor screw drive;

FIG. 1b: shows a valve unit having two coupled valves;

FIG. 2: shows a drive system having four valves;

FIG. 2a: shows a dual-circuit drive system having a pressure store;

FIG. 3a: shows a valve block having a valve switching-off mechanism between the camshaft and valve;

FIG. 3b: shows a camshaft adjustment mechanism with two contours;

FIG. 4a: shows a regulation method with four sequential valves;

FIG. 4b: shows a valve stroke variation with different control methods;

FIG. 5: shows a method for pressure pulsation control;

FIG. 6: is a simplified, schematic illustration of an embodiment of the valve control device having an additional pump with only two motor valves (with additional motor valves which are not illustrated being able to be fitted accordingly), and in order to explain measures for leakage compensation, for active venting and for complete cylinder shutdown.

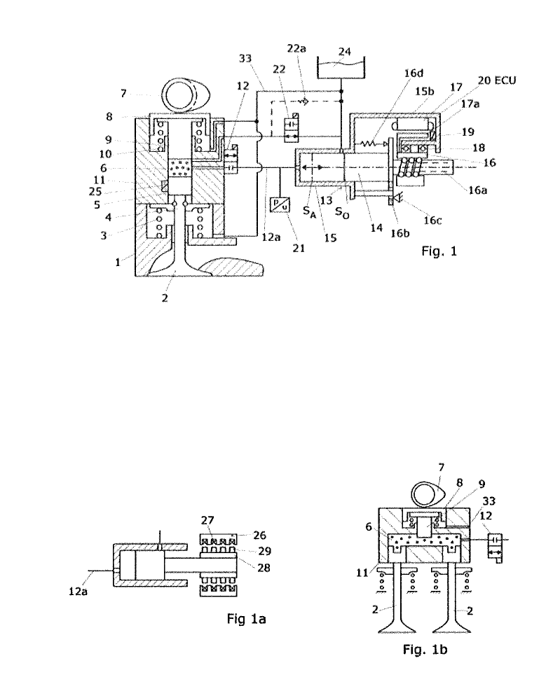

FIG. 1 shows the schematic structure of a variable valve control system of an inlet or outlet gas exchange valve (illustrated only as a cut-out) of an internal combustion engine, fitted in the cylinder head 1 of the internal combustion engine. In the cylinder head 1, a gas exchange valve 2 is pressed with a valve restoring spring 3 onto a valve seat which is formed in the cylinder head. The valve shaft 4 is operationally connected to a valve actuation piston 5 which delimits a valve hydraulic chamber 6. The valve hydraulic chamber is further delimited by a master piston 9 on which a camshaft 7 acts by means of a carrier 8. The master piston 9 is returned into position by means of a carrier restoring spring 10. Hydraulic components of the valve control system and the pistons are arranged in a cylinder head cap 11 which can be separated from the cylinder head 1. The hydraulic cap 11 is connected by means of a hydraulic line 12a and a switching valve 12 to a plunger piston/cylinder unit 13. An operating chamber of the plunger piston/cylinder unit 13 is formed by a housing 15 and a plunger piston 14 which is arranged so as to be able to be displaced therein. The plunger piston 14 is driven by means of a drive, in particular by means of a ball screw drive 16, the piston 14 being securely connected to a spindle 16a of the ball screw drive 16. Alternatively, a drive solution is also conceivable in which the motor is connected to the spindle by means of a gear (for example, a spur gear) or is arranged in an offset manner and connected to the ball screw drive by means of a toothed belt.

The plunger piston 14 has the zero position s0 in front of a breather hole 15a which leads via a hydraulic line to a hydraulic medium reservoir 24 so that in this position hydraulic fluid can be drawn from the reservoir. At sA, the plunger piston 14 is in an operating position (illustrated with dashed lines). The plunger piston 14 is returned by means of one or more restoring springs 16d into the zero position s0 in which it is in abutment with a stop 16c. The plunger piston 14 can be adjusted in both directions by means of the ball screw drive via a drive which is described below so that the operating chamber or the volume in the operating chamber of the piston/cylinder unit 13 can be increased or decreased accordingly.

The drive which drives the ball screw drive 16 has an electric motor 17 (stator and rotor) with a corresponding bearing 18 and angle sensor 19. In the system, there is further provided a pressure sensor 21 and an additional 2/2 switching valve 22 which connects the valve hydraulic chamber 6 to the hydraulic medium reservoir 24. This valve 22 is used for venting the system and the emergency operation control. As a replacement (illustrated in FIG. 1 with dashed lines) for the switching valve 22, it is also possible to use a simple non-return valve 22a. For stroke measurement in this instance, optionally only one valve stroke sensor 25 is provided for a gas exchange valve. This serves to further calibrate the regulation (pressure/stroke relationship at different temperatures) and to improve the quality of the valve stroke regulation. For very precise regulation requirements, it is also possible to use a plurality of valve stroke sensors, as long as the costs of the system allow this and the requirements in terms of precision of the regulation of the gas exchange valves require this. This may be the case in particular with specific combustion methods.

During normal operation without valve stroke variation, the camshaft acts via the carrier 8 and the piston 9 on the valve hydraulic chamber 6 and the valve 12 is closed. In this instance, the force of the camshaft is transmitted via the hydraulic medium which is enclosed in the hydraulic chamber and the piston 5 to the gas exchange valve 2. Preferably, oil is used as the hydraulic medium so that no sealing complexity is required and motor oil can be used for the valve stroke actuation and the motor lubrication. The oil is acted on with pressure, wherein the pressure is formed and adjusted by the plunger drive unit in order to prevent compression strokes so that the valve can follow the cam contour as directly as possible without any time delay. This is necessary in order to achieve a precise valve stroke. During valve drive, leakages occur. The leakage flows in the valve drive are returned via a return line 33 to the hydraulic medium reservoir 24. Via the switching valve 22 or the non-return valve 22a, hydraulic medium which was lost as a result of leakages is guided out of the hydraulic medium reservoir 24 in the “valve closed” position.

During operation with valve stroke variation, the valve 12 is opened and closed during the camshaft stroke and a corresponding movement of the master piston 9. Volume from the hydraulic chamber 6 is taken up by corresponding movement of the plunger piston 14 from the operating chamber of the piston/cylinder unit 13 and returned to the valve hydraulic chamber 6. Should the valve stroke be reduced in comparison with the stroke predetermined by the camshaft, the piston 14 is moved backwards in the valve opening movement (the volume in the operating chamber of the piston/cylinder unit 13 is thereby increased) and moved forward again in the valve closure movement so that the original volume is returned to the hydraulic chamber 6 again when the valve is closed. If a larger valve stroke than predetermined by the camshaft is desired, additional volume can be conveyed into the hydraulic chamber 6 via the piston/cylinder unit 13 and is removed again at “valve closure”.

Via the control of the piston of the piston/cylinder unit 13, any valve opening contours, substantially limited only by the dynamics of the plunger drive unit, can be achieved. The control of the valves and the drive are carried out by means of an electronic control and regulation unit (ECU) 20. The control of the volume is carried out by means of a stroke regulation of the piston 14 of the piston/cylinder unit via an angle sensor 19 of the electric motor. In a simple variant, it is possible to dispense with the pressure sensor 21 by conclusions being drawn in relation to the drive torque and the pressure in the plunger compression chamber by means of a current measurement of the phase current. The current measurement can also be used for control in the event of a malfunction (failure of the pressure sensor).

The 2/2-way switching valve 12 is provided with a large cross-section so that the volume flow is not throttled and large volume flows can be achieved. Another switching valve 22 is arranged in a hydraulic line which leads from the hydraulic chamber 6 to the hydraulic medium reservoir 24. The second 2/2-way switching valve 22 has the function that volume missing from the hydraulic medium reservoir 24 as a result of leakage can be subsequently supplied or can be returned to the oil circuit and serves to vent the system. In the event of a failure of the drive unit, this valve 22 can additionally be used as a suction valve in order to convey the volume into the valve hydraulic chamber. The valve may also be constructed as a simple non-switchable blocking valve 22a which enables volume flow in only one direction (from the hydraulic medium reservoir 24 to the valve hydraulic chamber 6).

The pressure sensor 21 serves to control the volume flow and adjust the basic pressure in the valve hydraulic chamber and to detect variable viscosity under the influence of temperature. The control is carried out based on a model by means of pressure/volume characteristic lines. An additional valve stroke sensor 25 serves to balance the control and regulation and is preferably provided in a circuit in a valve and optionally as an insert in all valves. In particular as a result of temperature influence, the medium properties change (volume flow, leakage flow). This can be determined with the valve stroke sensor 25 and the precision of the valve stroke regulation can consequently be significantly improved since these changes can be identified during operation. In addition, the valve stroke sensor 25 can be used for the regulation and pressure fluctuations can be reduced.

During emergency operation (failure of the electric motor), the valve 12 is closed and the valve drive is operated at full stroke. Via the valve 22 or 22a, hydraulic medium is conveyed in accordance with the leakage of the system. If the power supply drops, the system is fully operational. The valve stroke can no longer be varied.

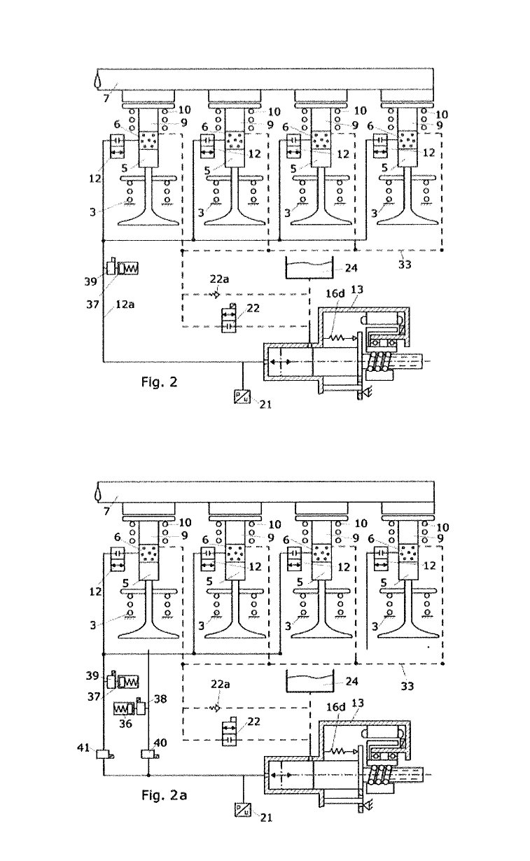

If the switching valve 12 fails in the open position in the event of a second malfunction (for example, incoming particle flow), the operation is stopped in variable valve stroke. The system is then operated only in full stroke operating mode. The motor then remains in a fixed position and is no longer controlled in the context of taking up volume and compensates only for volume flows in order to control the full stroke and the other valves 22 are closed (see in this regard also FIG. 2). This is necessary since, with a sequential operation of valves, an open valve of a switching valve which is not active would lead to undesirable valve opening. Hydraulic fluid is conveyed via the valve 22 or 22a.

FIG. 1a shows an alternative embodiment of the plunger drive unit, in which the motor gear unit is replaced by a linear actuator 26. The linear actuator comprises a stator having coils 27 and a rotor 28 having permanent magnets 29.

As an alternative to a linear actuator, it is also possible to use a segment motor comparable with the valve drive actuator of DE 10 2006 013 100 A1.

FIG. 1b shows an alternative embodiment of the hydraulic cap 11 in which 2 or more valves can be actuated with a common valve hydraulic chamber 6 and a camshaft, wherein the valve hydraulic chamber is connected to the plunger drive unit by means of a switching valve 12.

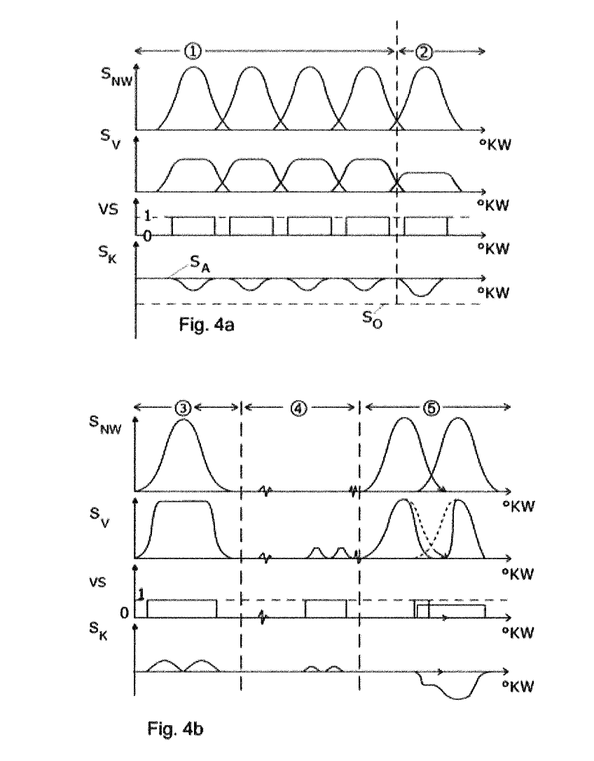

FIG. 2 shows the entire drive system 4 for valves of 4 cylinders. The valve units of 4 valves are each connected to the plunger piston/cylinder unit 13 by means of a switching valve 12. A camshaft 7 actuates the individual cylinders with the same camshaft contour in each case. All the valves are controlled in multiplex operation by means of a plunger piston/cylinder unit which is operated by means of a drive unit, that is to say, the valve stroke variation can be carried out sequentially or partially simultaneously, which is generally not a problem since the valve elevation curves of the individual cylinders follow sequentially one after the other. In addition, for the entire circuit (4 valves) a valve 22 or 22a is provided for conveying/venting. For reasons of redundancy, it is advantageous to use 2 valves (22 and 22a). The control is set out in greater detail in FIG. 4. In addition, for the system, a pressure store 37 can be used together with another switching valve 39. This pressure store can be used for emergency operation, in particular in the event of a failure of the electric motor when pressure is no longer present in the system.

In FIG. 2a a dual-circuit drive system is illustrated, wherein for each circuit a pressure store 36 and 37 with a valve 38 and 39 which is located upstream is provided, respectively. A separation valve 40 and 41 which is in each case associated with a hydraulic circuit is provided in the lines from the plunger piston/cylinder unit 13 to the valves 12, respectively. Consequently, simultaneous pressure build-up or pressure reduction of overlapping valves is possible (valves of sequential cylinders or inlet and outlet valve). The first and third cylinder which are associated with a first hydraulic circuit and the second and fourth cylinder which are associated with a second hydraulic circuit are thus each in a separate pressure circuit. As a result, with corresponding additional complexity, the variability can be even further improved. In addition, the emergency operation can be improved by the use of the switchable pressure stores.

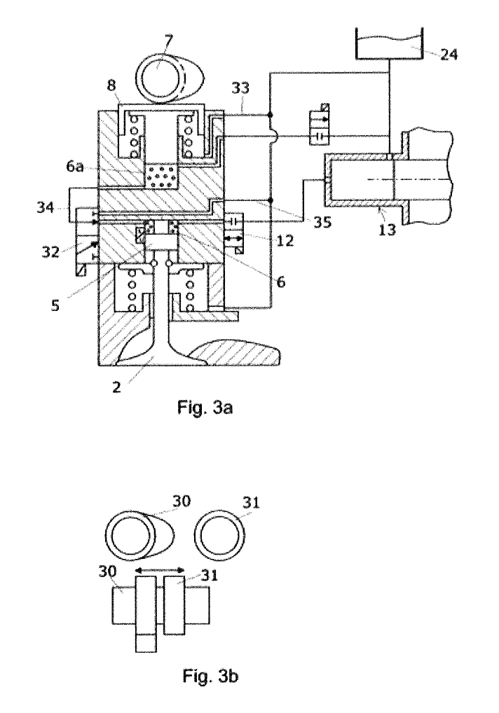

FIG. 3a shows a hydraulic solution for the switching between the camshaft and operation with the decoupled camshaft. The camshaft 7 is on a first camshaft hydraulic chamber 6a which is connected to the valve hydraulic chamber 6 and the hydraulic medium reservoir 24 by means of a hydraulic line 33 and a 3/2 separation switching valve 32. If the separation switching valve 32 is closed, the camshaft is decoupled from the valve hydraulic chamber. The hydraulic medium in 6a is then returned with a camshaft stroke via a hydraulic line into the hydraulic medium reservoir 24 and conveyed again via the valve. Consequently, the gas exchange valve is separated from the camshaft pressure actuation and can be controlled exclusively via the valve 12 and the plunger piston/cylinder unit 13 or the associated drive. Consequently, the energy requirement for the partial-load operation can be minimised since only small volume flows and stroke movements are required and no compression losses of the camshaft occur.

FIG. 3b shows an adjustable camshaft contour, as used, for example, in EP 213241881 (to which reference will also be made here for disclosure or further explanation). Via an adjustment mechanism, the camshaft can be axially displaced and the camshaft contour which acts on the hydraulic system can be varied. This has the advantage that existing mechanical valve drives can be taken over and the stroke variation is carried out on the basis of two different camshaft contours (maximum stroke contour and zero stroke). This has a positive effect on the electrical power requirement of both large and small strokes since the volume flow and consequently the power requirement can be minimised. A camshaft contour with full stroke would in particular be used for maximum load and a camshaft contour with zero stroke for small strokes and partial load operation. Consequently, the power requirement of the drive system can be minimised with low costs and the valve drive system can also be operated with a standard on-board system voltage of 12V.

In the context of a low power requirement, an electric motor with the smallest possible mass of inertia (inner rotor or inner rotors with a dual air gap) or a linear actuator with a small rotor mass or segment motor (as described, for example, in DE 102006013100 A1 of the Applicant, which will be referred to in this instance for disclosure and description of further details) is intended to be used. In addition, a hydraulic translation between the valve hydraulic chamber and plunger hydraulic chamber is advantageous in order to minimise the overall mass inertia and the torque requirement/power requirement. The hydraulic system is preferably intended to be constructed in such a manner that the entire mass inertia (valve+plunger piston/cylinder drive unit) is minimised in total.

FIG. 4a illustrates the control method. In the upper region of the image, the camshaft stroke sNW of sequential valves is illustrated as a function of the crankshaft angle ° kW. Below this the stroke path of the valve sV, the switching position of the switching valves (1: open/0: closed) and the piston stroke sk of the plunger drive unit are illustrated. As soon as the stroke path of the camshaft should deviate from the desired valve stroke, the valve is opened and the plunger sk is adjusted. The plunger operates based on the operating stroke position sA and during operation is always in front of the initial position s0. The volume is taken up as far as the maximum stroke and returned again afterwards. As soon as the desired valve stroke corresponds again to the camshaft valve stroke, the valve can be closed again and the remaining valve stroke is predetermined by the camshaft. In phase (1), this sequence is the same for all successive valves so that, in spite of overlapping of the camshaft paths, the plunger control can be carried out in a sequential manner since, at the beginning and at the end of the valve elevation, no control intervention is required. In phase (2), the stroke Sv is reduced and the piston movement consequently increases since more volume has to be displaced.

During real operation, a corresponding pre-control is required since both the switching valves have downtimes and the pressure is built-up and reduced in a time-delayed manner. This is intended to be taken into account in the regulation and is not precisely set out in the schematic illustration.

FIG. 4b shows other valve stroke variation possibilities and the corresponding control. In phase (3), a larger valve stroke Sv is desired than the camshaft profile. In order to achieve this, the valve is opened at the beginning of the valve elevation curve and increased by means of a positive piston movement sk of the valve stroke. This method is advantageous in order to achieve large valve opening cross-sections and to achieve more filling in the cylinder at maximum motor load.

In phase (4), no stroke is produced by the camshaft by camshaft decoupling according to FIG. 3a or decoupling of the camshaft according to FIG. 3b. Successive freely variable small strokes can be achieved by means of small stroke movement of the piston with minimal power.

In phase (5), a specific feature of the multiplexing is illustrated in which two switching valves of two successive valves (for example, outlet and inlet) are temporarily opened at the same time and consequently an overlapping of the valve elevation curves is prevented. The first valve is closed early and the second valve is opened late and consequently desirable negative pressures are achieved in the cylinder. Both valve curves can be controlled at the same time by the plunger.

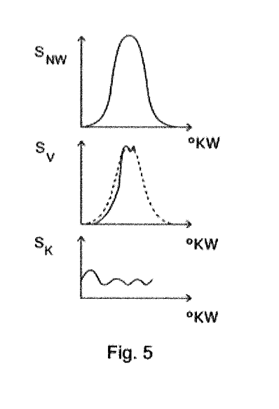

FIG. 5 additionally shows a pressure pulsation control system. In the upper image, the camshaft elevation curve is illustrated. As a result of dynamic effects, resulting from the compressibility of the hydraulic fluid, pressure fluctuations and pressure increase downtimes and consequently valve oscillations and angle distortion may occur. This pressure oscillation can be counteracted by means of corresponding plunger control sk.

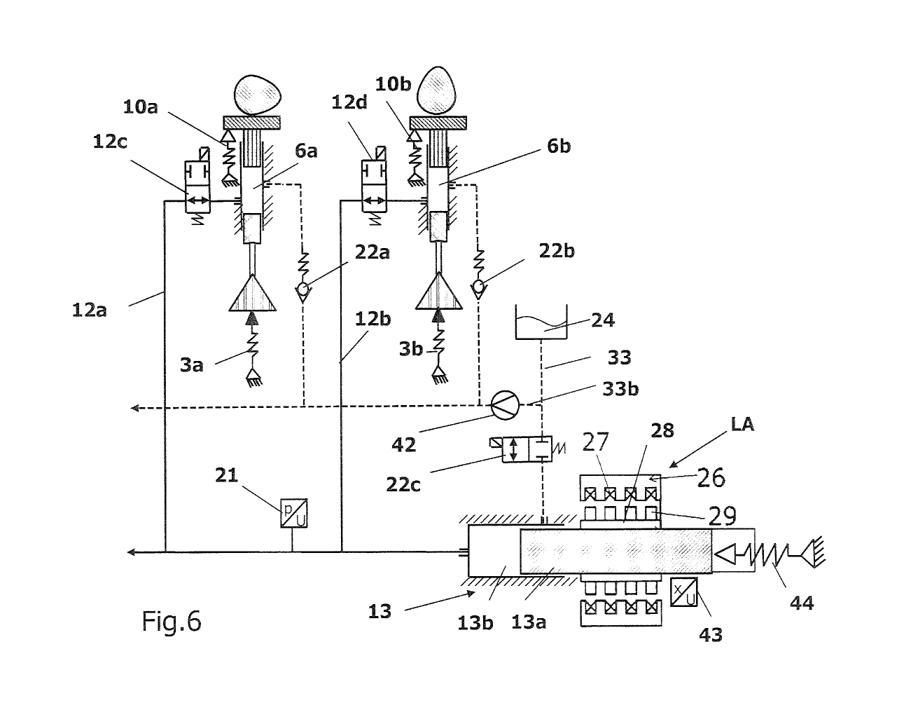

The embodiment of a device for variable electrohydraulic valve control illustrated in FIG. 6 substantially corresponds to the valve control system illustrated in FIG. 1. In contrast to this, a current-free open (control) valve 12c, 12d is connected to the hydraulic lines 12a, 12b which connect valve hydraulic chambers 6a, 6b in the operating chamber of the piston/cylinder unit 13, respectively. Furthermore, in a line 33 which connects the piston/cylinder unit 13 to a hydraulic fluid reservoir 24, a current-free closed switching valve 22c is arranged and, in a hydraulic line 33b which branches off from the line 33 and which is connected to the valve hydraulic chambers 6a, 6b in each case by means of non-return valves 22a, 22b, a pump 42 is arranged. As in FIG. 1, a pressure sensor 21 is arranged in the line which leads from the piston/cylinder unit 13 to the valve hydraulic chambers 6a, 6b. The piston 13a of the piston/cylinder unit 13 is provided with a displacement sensor 43 and is actuated by means of a linear actuator LA (comprising 26-29, as described in FIG. 1a), as described in FIG. 1a.

Using the pump 42, leakage losses can be compensated for via the non-return valves 22a, 22b. If the pressure in the valve hydraulic chambers 6 falls below the pressure level of the pump, a fluid flow begins via the non-return valves. The non-return valves 22a, 22b lock in the counter-direction, that is to say, volume never flows in the direction of the pump, even when during a modulation higher pressures are produced than the pressure level of the pump 42. In particular for each valve hydraulic chamber 6a, 6b, a non-return valve 22a and 22b is provided so that no transverse flow can be produced between the valve hydraulic chambers (which, in the event of modulation on a valve in the basic circuit phase of the cam, would otherwise be possible). The pump pressure maintains a minimum pressure in the valve hydraulic chambers, whereby the “hydraulic rod assembly” is pretensioned. The higher the minimum pressure, the better the valve stroke follows the cam stroke, with a reduction of the compression losses being carried out. In a simple embodiment, the oil pump of the internal combustion engine is used as a pump and the motor oil is used as a medium for the valve drive. In order to reduce the compression losses, an oil pump with a higher pressure, for example, 10 bar is advantageous or a separate oil circuit. This leads to higher control time precision (less air in the oil, more rigid system), but also higher system costs.

With the solenoid valve 22c open, the linear actuator LA moves the piston 13a of the piston/cylinder unit 13 back and thus produces by means of differential pressure with respect to the hydraulic valve chamber 6 a volume flow in the operating chamber 13b of the piston/cylinder unit 13 or when the linear actuator is activated, back into the hydraulic valve chamber. The valve stroke is thereby controlled. A spring 44 supports the actuator movement and reduces by means of corresponding configuration taking into account the other resilient forces in the system (valve and carrier restoring spring 3, 10) the required linear actuator force and consequently reduces the power requirement. In addition, leakage losses can be compensated for directly in the piston/cylinder unit 13 by volume from the piston/cylinder unit being conveyed into the hydraulic valve chamber 6 by forward movement of the piston 13 by means of actuation of the linear actuator.

With the solenoid valve 22c open and at the same time at least one open solenoid valve 12c, 12d (control valve(s)) on the valve hydraulic chambers, there begins a volume flow which is driven by the pump 42 or alternatively by the linear actuator LA. This is advantageous when the pump is mechanically driven only by the internal combustion engine and cannot be used for venting during downtime. Via the valve hydraulic chambers 6a, 6b and the control valves 12c, 12d, the piston/cylinder unit 13 and the solenoid valve 22c which is open for this purpose in the container 24, it is thus possible to carry out an active venting routine. As a result of the venting, the control precision is improved since the hydraulic medium (oil) becomes “stiffer” or less resilient. At the same time, there is a reduction of the compression losses.

For an emergency operation or system component failure, it is advantageous to construct the valves 12c and 12d so as to be open in a current-free state. In the event of a valve failure, the volume can consequently be displaced out of the valve hydraulic chamber into the piston/cylinder unit. It is thereby ensured that there is no collision between the gas exchange valve 2 and the motor piston as a result of volume being conveyed into the hydraulic chamber of the relevant valve. With appropriate safety measures (for example, valve stroke control), the valve can still be controlled by the piston/cylinder unit by volume being conveyed via the linear actuator. The other remaining valves can still be controlled in emergency operation without limitation by the control method described without limitation.

In the event of system failure of the valve control device, all the valves 12c, 12d are then open and the volume from the valve hydraulic chamber is conveyed into the valve hydraulic chamber in the piston/cylinder unit. The hydraulic chamber then acts as a storage chamber and conveys the volume back into the hydraulic chamber again. Consequently, the motor can continue to be operated. Leakage losses are compensated for by means of the pump.

For a shutdown of the cylinder of the motor, it may be sufficient to hydraulically switch off the inlet valves of the cylinder (both at the same time). To this end, the solenoid valve 22c can be opened, together with an opened control valve 12c or 12d. The cam which is associated with the cylinder then pushes the hydraulic medium via the piston 13a into the pressure-free storage container 24. This type of switching-off is only one of other possible switching-off operations, that is to say, it is optional.

In the embodiment illustrated in FIG. 3a, a 3/2 solenoid valve 32 is used for complete shutdown. Advantageously, a complete shutdown can also be carried out by means of the piston/cylinder unit 13, as explained below with reference to FIG. 6. With the solenoid valve 22c closed, the piston/cylinder unit with the piston 13a and the auxiliary spring 13c behaves in the manner of a storage chamber and can be used as such for complete shutdown of valves or when both valves are switched off in order to switch off the relevant cylinder. To this end, the following control procedure is in particular carried out. The control valve 12c or 12d of the relevant cylinder is opened when the cam stroke begins. Hydraulic fluid is moved by the cam stroke, which leads to the pressure increase in the valve hydraulic chamber, the piston/cylinder unit and the hydraulic line which is located therebetween. The piston 13a is thereby moved counter to the resilient force of the auxiliary spring 44 and intermediately stores the energy applied by the camshaft. In addition, the hydraulic energy is converted by means of energy conversion of the linear actuator into electrical energy and supplied to the on-board system and consequently leads to minimised losses. In this instance, the piston/cylinder unit takes up the stroke of the cam completely, which brings about the desired complete shutdown (zero stroke of the motor valves).

Using the pressure sensor 21, it can be established whether there is a risk of a motor valve opening. In this instance, by means of appropriate control of the electric actuator, the piston/cylinder unit of the piston can be supported in terms of its movement in such a manner that the motor valve does not open.

### LIST OF REFERENCE NUMERALS

1 Cylinder head
2 Gas exchange valve
3 Valve restoring spring
4 Valve shaft
5 Valve actuation piston
6a Camshaft hydraulic chamber
6 Valve hydraulic chamber
7 Camshaft
8 Carrier
9 Master piston
10 Carrier restoring spring
11 Cylinder head cap with hydraulic components
2/2 switching valve with large cross-section
12a Hydraulic line
12n Hydraulic line
12c Current-free open solenoid valve
12d Current-free open solenoid valve
13 Plunger piston/cylinder unit
13a Piston
13b Operating chamber
14 Plunger piston
14a Plunger piston restoring spring
15 Housing
15a Breather hole
15b Motor housing
16 Ball screw drive
16a Spindle plunger piston pulling rod
16b Spindle torsion prevention mechanism
16c Stop position of the piston
16d Piston restoring spring
17 Electric motor
17a Rotor
18 Bearing of the motor screw drive
19 Angle sensor
20 Control and regulation unit (ECU)
21 Pressure sensor
22 2/2 non-return valve
22a Non-return valve
22b Non-return valve
22c Solenoid valve which is closed in a current-free state
23 Plunger volume
24 Hydraulic medium reservoir
25 Valve stroke sensor
26 Electric linear actuator
27 Stator of the linear actuator with exciter coils
28 Rotor of the linear actuator with permanent magnets
30 Camshaft contour for a large valve stroke
31 Camshaft without contour for zero stroke
32 3/2 switching valve
33 Hydraulic line
34 Hydraulic line
35 Hydraulic line
36 Pressure store
37 Pressure store
38 Valve
39 Valve
40 Separation valve
41 Separation valve
42 Pump
43 Displacement sensor
44 Auxiliary spring
45 LA
skW Camshaft stroke
sV Valve stroke
vS Valve position of the switching valve 22 on/off
sk Plunger stroke
s0 Initial position of the plunger piston
sA Operating position of the plunger piston

1. A variable electrohydraulic valve control system, including:
a piston configured to actuate a valve,
a valve hydraulic chamber delimited by the piston,
at least one piston/cylinder unit connected to the valve hydraulic chamber by means of a hydraulic line in which a switching valve is arranged, and
an electric motor drive configured to drive the piston of the piston/cylinder unit.

2. The valve control system according to claim 1, wherein the electric motor drive comprises a rotation motor which is connected by means of a gear or a ball screw drive to the piston of the piston/cylinder unit.

3. The valve control system according to claim 1, wherein the electric motor drive comprises a linear motor.

4. The valve control system according to claim 1, wherein at least two controlled valves have a common drive or motor.

5. The valve control system according to claim 1, wherein at least two controlled valves are connected by means of a switching valve and hydraulic line to the piston/cylinder unit.

6. The valve control system according to claim 5, wherein a switching valve having a large cross-section is arranged in the hydraulic line corresponding to a respective controlled valve.

7. The valve control system according to claim 1, wherein the piston of the piston/cylinder unit has a piston restoring spring.

8. The valve control system according to claim 1, wherein a plurality of controlled valves are controlled in a multiplex method sequentially, simultaneously or partially simultaneously.

9. The valve control system according to claim 1, wherein control is carried out by means of path control of the drive or the piston/cylinder unit.

10. The valve control system according claim 1, wherein control is based on an evaluation of a pressure/volume characteristic line of a valve hydraulic chamber with plunger.

11. The valve control system according to claim 1, wherein pressure in an operating chamber of the piston/cylinder unit or in the valve hydraulic chamber is determined by means of a pressure sensor or by means of a current measurement of a phase current of the electric motor drive.

12. The valve control system according to claim 1, wherein a volume control of the piston/cylinder unit is used to compensate for hydraulic pressure fluctuations.

13. The valve control system according to claim 1, further including a hydraulic translation provided between the valve hydraulic chamber and an operating chamber of the piston/cylinder unit.

14. The valve control system according to claim 1, further including a second piston that delimits the valve hydraulic chamber, wherein the second piston is configured to be actuated by means of a mechanical device.

15. The valve control system according to claim 14, wherein the mechanical device is configured to be decoupled from the piston-cylinder unit and the electric motor drive by means of a 3/2 separation valve or a camshaft displacement mechanism.

16. The valve control system according to claim 1, further including a valve device configured to vent the system.

17. The valve control system according to claim 1, further including a valve device provided for emergency operation of the system.

18. The valve control system according to claim 1, further including a controllable pressure store, wherein the valve hydraulic chamber is connected to the controllable pressure store by means of a hydraulic line.

19. The valve control system according to claim 1, further including a pump associated with at least one valve and configured to convey hydraulic medium into one or more conveying chambers of the at least one valve.

20. The valve control system according to claim 19, further including at least one non-return valve configured such that the hydraulic medium is carried by means of the pump via the at least one non-return valve, into the one or more conveying chambers.

21. The valve control system according to claim 19, further including a solenoid valve, which is configured to be open in a current-free state, wherein the solenoid valve is arranged upstream of the one or more conveying chambers.

22. The valve control system according to claim 19, further including a solenoid valve, which is configured to be closed in a current-free state, wherein the solenoid valve is connected in a hydraulic line which leads from the piston/cylinder unit to the pump and to a storage container.

23. The valve control system according to claim 19, wherein the pump is the oil pump of an internal combustion engine.

24. The valve control system according to claim 19, wherein the pump has an oil pressure of 10 bar or more, and a separate oil circuit is provided, or both.

25. A method for the variable electrohydraulic control of one or more gas exchange valves of an internal combustion engine, the method including:
supplying hydraulic medium to a valve hydraulic chamber associated with the one or more gas exchange valves by means of an electronically controllable device; and
discharging the hydraulic medium from the valve hydraulic chamber.

26. The method according to claim 25, wherein the one or more gas exchange valves include more than one gas exchange valve, and wherein the method further includes controlling the gas exchange in a multiplex method sequentially, simultaneously or partially simultaneously.

27. The method according to claim 25, further including evaluating a pressure/volume characteristic line, for control.

28. The method according to claim 25, further including determining pressure by means of a pressure sensor or by means of a current measurement of a phase current of a drive motor.

29. A method for maintaining a pressure level, for leakage compensation, and/or for active venting of a valve control with a driven piston/cylinder unit according to claim 19, the method including supplying hydraulic fluid from a storage container to the one or more valve conveying chambers in a controlled manner, using the pump.

30. A method for maintaining a pressure level, for leakage compensation, and/or for active venting of a valve control with a driven piston/cylinder unit according to claim 1, the method including supplying hydraulic fluid from a storage container to one or more valve conveying chambers associated with one or more valves using the at least one piston/cylinder system.

31. A method for complete shutdown of one or more valves, the method including using the at least one piston/cylinder unit of the valve control system according to claim 1 as an intermediate storage for storing energy applied by a camshaft.
